(19) United States
(12) Patent Application Publication
(10) Pub. No.: US 2011/0060695 A1
(43) Pub. Date: Mar. 10, 2011

(54) System and Method for Automated Admissions Process and Yield Rate Management

(76) Inventor: Thomas Boyland, Falls Church, VA (US)

(21) Appl. No.: 12/909,691

(22) Filed: Oct. 21, 2010

Related U.S. Application Data
(63) Continuation-in-part of application No. 10/761,562, filed on Jan. 21, 2004, now abandoned.
(60) Provisional application No. 60/484,034, filed on Jul. 1, 2003.

(51) Int. Cl. G06Q 50/00

(52) U.S. Cl. 705/327

(57) ABSTRACT

Admissions processing, management and yield rate improvement is enabled through an automated submission, management, notification, matching and status indication system in accordance with the present invention. The present invention provides an applicant component enabling applicants to submit an application for admission and receive status information about their application. The present invention further provides a management component for personalizing communications, scheduling interviews and on-site visits, and categorizing, assigning and evaluating the application. The present invention further provides a matching component to assist the admissions office personnel in qualifying candidates for admission, determining the most likely candidates from the qualified candidates to accept an offer, and matching prospective students with current students for tours and other applicant services. The present invention further provides a communications component for notifying admissions office personnel of assigned applications and allowing applicants to view the application status. The present invention can integrate with previously established interfaces and databases, and can be customized for specific user needs.

### CROSS REFERENCE TO RELATED APPLICATIONS

This application claims the benefit of U.S. application Ser. No. 10/761,562, filed Jan. 21, 2004, which claims the benefit of U.S. application Ser. No. 60/484,034, filed Jul. 1, 2003, both entitled “System and Method for Automated Admissions Process Management”.

### FIELD OF THE INVENTION

The present invention relates to workflow processing, and more particularly to managing the admissions workflow processing, yield rate and other elements for educational and other institutions.

### BACKGROUND OF THE INVENTION

High schools, colleges, camps, private schools and other institutions that routinely accept and evaluate applications suffer from vast amounts of paperwork requiring quick and efficient processing. Oftentimes, such paperwork is received in a very short time frame—usually around an application deadline—and the tasks of repetitively keying in data and managing such paperwork are cumbersome and costly. Additionally, while schools and other application-handling entities frequently have their own databases (electronic or otherwise) of student or applicant information, they are ill-equipped to handle the addition and transfer of new/updated information from outside sources to such databases. Further, these institutions are typically overwhelmed with little time and few resources to apply toward increasing the yield of the admissions process, where yield includes the number of successful applications and/or acceptances divided by the number of issued offers. Even further, these institutions are increasingly challenged to improve yield according to the school's mission. In addition to the large amounts of unprocessed data, the insufficient time and ability to analyze the data year to year and the haphazard ways in which institutions attempt to realize their missions, institutions suffer from turnover in the managing offices, which results in the loss of institutional knowledge and process.

### SUMMARY OF THE PRESENT INVENTION

One aspect of the present invention provides a full-fledged suite of office automation tools including a web front-end to assist with many of the common and not-so-common admissions office tasks. The present invention assists admissions offices in managing data and processes from applicant input to storage, evaluation and comparison with later applicants over ensuing years. In one embodiment, the present invention can be integrated easily with legacy systems, such as an offline admissions database, for example. The present invention also allows admissions office personnel to customize processing, management and personalization of information. Further, using the present invention, communications to applicants can be automatically personalized, and admissions personnel can create and retrieve personal notes related to applicants for use in applicant evaluations and interviews.

A further aspect of the system of the present invention helps maximize the yield rate of the admissions cycle. Yield rate is the number of applicants that agree to come to the school out of those that have been offered admission. Most schools focus on getting the yield rate higher, and the present invention is able to facilitate improvement in the yield rate through a matching algorithm. Past efforts by school officials to improve yield rate have been largely manual, include the subjective decision making of the admissions team at the time, and fluctuate depending upon the personnel in the office. The present invention helps maximize the yield rate by assisting in student selection based on, for example, the institution's strategic needs (e.g., mission, activities) and matriculation likelihood.

In one embodiment of the present invention, yield rate is improved by using a matching algorithm associated with the present invention that compares the newly received admissions data with historical admissions data that has been archived. The present invention extracts the data from the new applications and stores it in the institution databases based on key elements of the application. The present invention further provides a yield management component to automatically analyze and evaluate the data, comparing the key elements with the database to enhance the student selection process. Further, the present invention tracks applicants through matriculation and records the final institution of their choice. The present invention further tracks the applicant through the institution of their choice to record the level of success at the next step or level.

In one embodiment of the present invention, data collection is initiated at the time a new application is submitted. Selection assistance functionality associated with the present invention can analyze the data to predict success and initiate the process whereby an applicant is accepted for admission. If the student is ultimately accepted and enrolls with the institution, the data can be transformed into enrollment data and subsequently into tracking and analysis data.

The system of the present invention further assists institutions with the ongoing problem of changing personnel. Schools traditionally struggle with turnover in the administration and admissions office. When the personnel changes, so does the process for admissions. There is no continuity. The system of the present invention provides the school with an admissions process that continues as personnel change. The system of the present invention records the process of the application as well as the evaluation process, and transforms the database into an information system that contains every aspect of the application and business strategy of the admissions office. For example, the present invention can record the time, day and number of applications along with other complex data structures during the admissions year. The data is then transformed into a workload estimator. The present invention not only assists with the current year yield rates, it can also estimate the application and yield rates for future years.

In addition, the present invention can extract geographic and zip code data to help predict where the current and future student body will be physically located, as well as to provide details on where and how many students should be marketed in the future. The present invention can further provide a computerized dashboard to show the trends and predictions for strategic and business planning purposes. In one embodiment of the present invention, the applicant component can use the application data, marketing data and strategic data to optionally provide dynamic responses and questions to each applicant during the application process. This can be used, for example, when key criteria are met that indicates an applicant is a potential high or low match with past successful students at the institution. In one embodiment of the present invention, the communication mechanism not only provides status data to the applicant, but requests other data to refine the data being processed. The present invention can further generate questions that can be used to improve statistical models used to assist in yield rate enhancement. In other words, when the system detects new data, other questions can be generated by the present invention to question the applicant to fill in missing “holes” in the application. This aspect of the present invention effectively and dynamically builds on the knowledge database associated with the present invention.

The scheduling module of the present invention can be used to schedule personal interviews. In one embodiment of the present invention, a matching algorithm associated with the scheduling module matches the applicant to a student from a database of students who are available to give the applicant a tour. The matching algorithm uses the database, incoming application data and historical data to find a match that will likely increase the chances of the student accepting and being successful.

In another aspect of the present invention, an instructor or teacher recommendation component is provided. This component allows authorized teachers from the student's institution to log into the system and provide recommendations to students.

The present invention further benefits current admissions and application processing systems through its web-enabled, browser-based application submission and status inquiry capabilities for applicants, and similar web-enabled, browser-based application processing, scheduling, personalization and review capabilities for admissions offices. The present invention thereby helps automate admissions and application processing for entities and offices of all types.

### BRIEF DESCRIPTION OF THE DRAWINGS

FIG. 1 is a block diagram showing several user types interacting with the system of the present invention.

FIG. 2 shows a block diagram of the components of one embodiment of the system of the present invention.

FIG. 3 is a diagram showing an exemplary architecture for implementing one embodiment of the system of the present invention.

FIG. 4 is a flow chart indicating a method for processing applications in accordance with one embodiment of the present invention.

FIGS. 5 and 6 show sample screen interfaces for use in connection with the present invention.

FIG. 7 is a flow chart indicating a method used in accordance with the matching algorithm of the matching component in one embodiment of the present invention.

FIG. 8 is a flow chart indicating a method used in accordance with the matching algorithm of the matching component in another embodiment of the present invention, to match prospective students with a current student for a school tour.

### DETAILED DESCRIPTION OF THE PREFERRED EMBODIMENTS

Figs. I and 2 are block diagrams representing the interaction of several user types with the system 10 of the present invention. Users can include applicants 14, office personnel 16, instructors 17 and admissions committee personnel 18. In one embodiment, alumni, parents and school principals can access the system of the present invention as well.

Access can be provided through a network 15 such as the Internet using a standard web-based browser as is commonly understood in the art. Access to the network can be via cable modem, dial-up modem, satellite, digital subscriber line or any other generally available access means. In one embodiment, applicants can access the present invention through the Internet, while admissions personnel access the present invention via local or wide area network. Thus, the present invention can be made a part of the admissions office information system backbone, accessible via local area network using a client workstation or PC, with remote access available when the office personnel are not in the office.

Applicant interface 14 can be used by applicants to send application-related information to a management component 20 of the present invention. Such application-related information can be an application itself or supporting elements thereto, and such information can be called primary application-related information. Examples of primary application-related information can include, for example, applicant identification information, an online application, a transcript, a letter of recommendation, a report card, a photograph, a video clip, or an audio clip. The receipt and storage of applicant identification information by the present invention assists in customizing and personalizing communications to applicants.

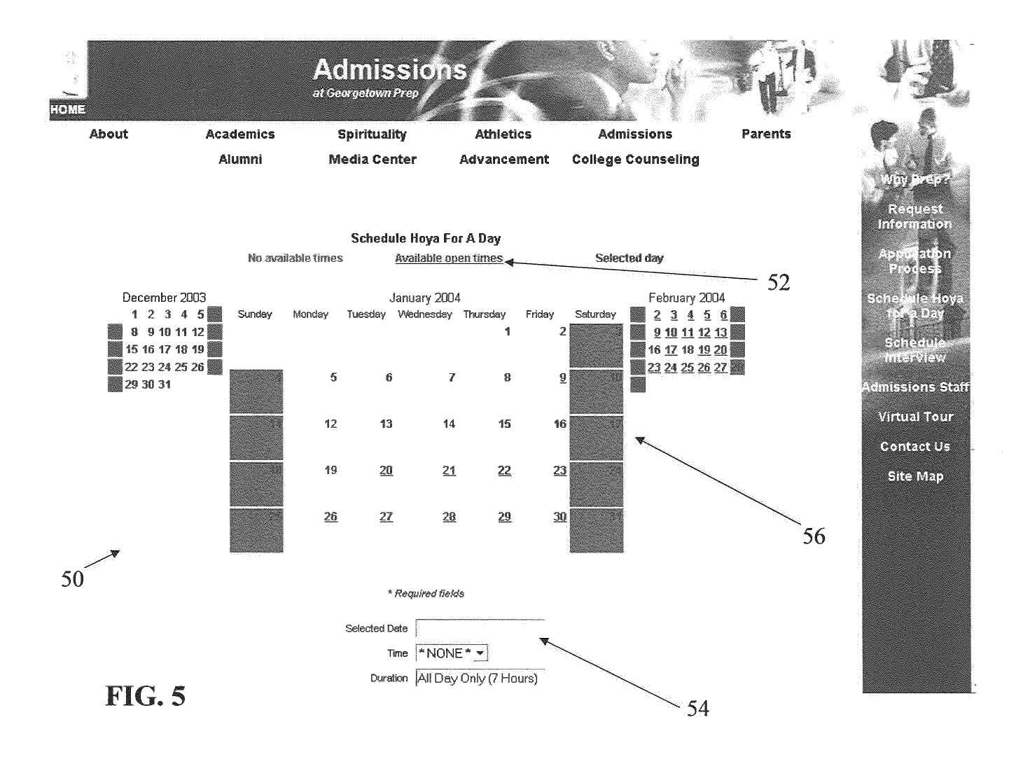

Paper-based information that is not sent electronically to management component can be mailed by applicant, scanned by the admissions office and made available for electronic manipulation and review. Applicant interface 14 can allow the applicant to perform various tasks related to the application process, including application submission using online forms or a compact disc, for example, as well as printing, saving and restoring an application. Applicants can further schedule interviews, tours and/or visits using interface 14. As shown in the sample user interface 50 of FIG. 5, a student can select either a group of available times and dates (such as available time selection 52) or a particular date through text input as at 54 or by selecting a date on calendar 56. The user's selection can be communicated to management component 20 so that administrators and other personnel can become aware of the user-scheduled visit.

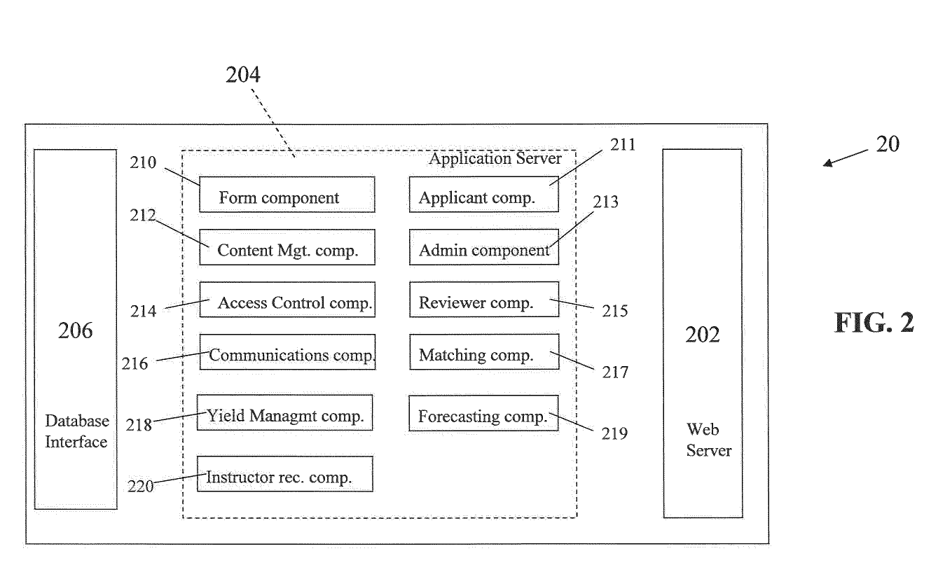

The management component 20 can receive the primary application-related information and store it in database 25. As different content types can be sent via applicant interface 14, it will be apparent that the management component is capable of handling a variety of file types, including text files, proprietary document file types (e.g., Microsoft Word™, PowerPoint™), video files (e.g., mpeg, avi), image files (e.g., jpg, img), and audio files. As shown in FIG. 2, management component 20 can include a web server 202, application server 204 and database interface 206. In one embodiment, as will be described more completely hereinafter, application-related information received online can be exported into an institution's database, such as a Blackbaud™ database, manufactured by Blackbaud, Inc. of Charleston, S.C.

Web server 202 can serve the interface pages from applicant component 211, administration component 213 and reviewer component 215, depending upon which entity type is accessing the management component. It will be appreciated that applicant 211, administration 213 and reviewer 215 components can be provided through application server 204 via web server 202 or can be client applications stored locally on client devices 14, 16 and 18. As shown in FIG. 2, application server also includes form generation component 210, content management component 212, access control component 214, communications component 216 and matching component 217. Other components that can be provided as part of management component include a yield management component 218, forecasting component 219 and instructor recommendation component 220.

In the process of arranging a visit for prospective students, management component 20 can incorporate matching component 217 to determine an appropriate current student or other individual to meet with and/or accompany the prospective student during the visit or tour of the institution. The matching algorithm can match the applicant to a student from a database of students who are available to give the applicant a tour or provide a different type of applicant-related service, such as a question and answer session, a class review, or an instructor review, for example. The matching algorithm also uses the database, incoming application data and historical data to find a match that will likely increase the chances of the student accepting.

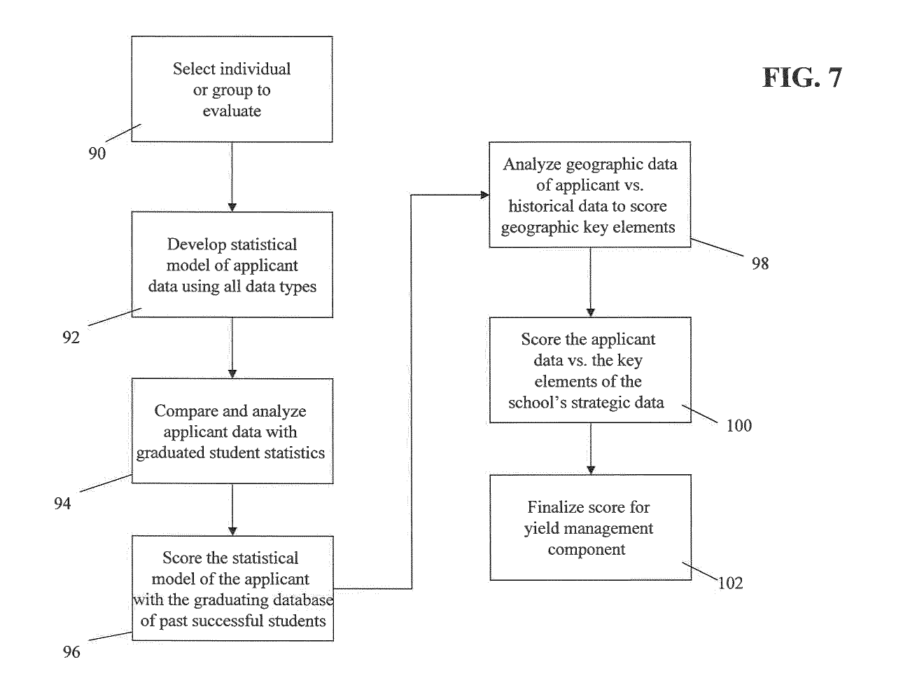

In one embodiment, the matching algorithm follows the steps as shown in FIG. 7. As shown therein, an individual or group of individuals is first selected for evaluation by an evaluator as at step 90. A statistical model of the applicant data is then developed by the matching component of the present invention using all data types, as at step 92. The applicant data is compared and analyzed by the yield management component with graduated student statistics, as at step 94. At step 96, the statistical model of the applicant is scored with the graduating database of past successful students using the yield management component. At step 98, the geographical data of the applicant is analyzed to score geographic key elements, using the matching component. The applicant data is then scored by the matching component against key elements of the school's strategic data, as at step 100. At step 102, the score is finalized by the matching component for use by the yield management component.

As an example use of the matching algorithm, suppose there is an applicant from grammar school Mater Dei, applying to Jesuit High School, a Catholic high school. The Jesuit High School has initially input data into the system about the strategic goals of the school. The key elements include a list geographic, demographic and academic data points. The data also include objective data points that are used for targeting success in the strategic model. For example, a school may want to measure the percentage of students that remain Catholic. As part of its missions, the school supports the development of Catholic students into leaders in the community. The target of the student body may be 85% of the total population. Serving underprivileged children and/or communities is another example of a goal identified as a part of the school's strategic model. Serving future growth areas and/or communities is another example that includes a geographic aspect. Each of these strategic metrics is developed into criteria that will be entered into the application as a student applies.

Using the matching component, the historical data is developed into a statistical model. The statistical model can be a set of mathematical equations describing the behavior of an element (e.g., an applicant) in terms of random variables (e.g., geographic location of residence, date of birth) and their probability distributions. Once the statistical model is developed, the matching component can scan the system database, converting patterns and trends into metrics. For example, assume that the students that have been successful graduates in the past and that have also been Catholics attended school at Mater Dei, and lived in a specific new development area. These important features are extracted from the historical data and used to develop the criteria for the incoming admissions application.

When an application is received, the data is analyzed to produce a statistical “footprint” of the applicant. That footprint is then used to scan the historical and strategic database. Through the transformation process, the system of the present invention can continually refine the statistic model to find the closet match footprint. This data is scored and weighted to help the decision process.

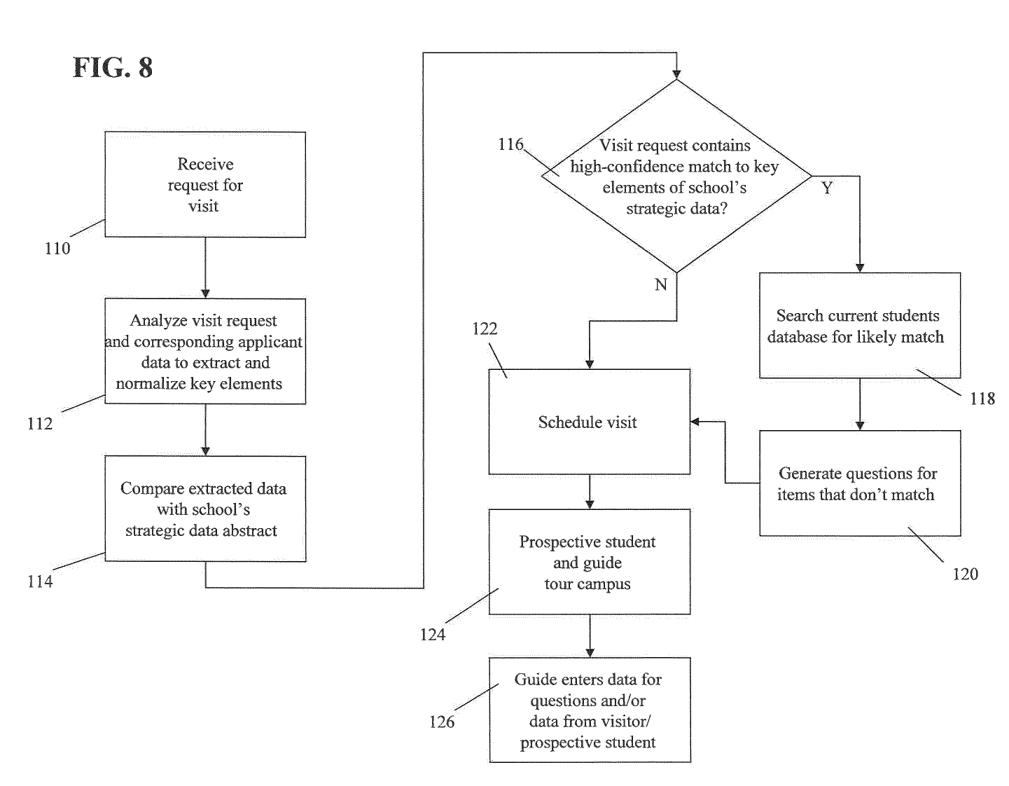

The matching component of the present invention can further be used when matching prospective students with current students for guided tours of the school. As shown in FIG. 8, for example, the system of the present invention first receives a request for a visit through applicant component, as at step 110. As at step 112, the applicant component can analyze the visit request and corresponding applicant data to extract and normalize key elements. This information is communicated to the yield management component. As at step 114, the matching component can compare the extracted data with the school's previously developed and stored strategic data abstract. At step 116, if the visit request contains a high-confidence match to key elements of the school's strategic data, as determined by the matching component, then the present invention searches the current student database for possible matches, as at step 118. The present invention can also generate questions for the applicant in the event there are items that do not match, as at step 120. For instance, if the applicant indicates an interest in travel, but there are no matches, the present invention may generate questions for the applicant, such as, for example, “Do you travel for sporting events or exercise?” or “Do you enjoy exotic foods?” By receiving answers to such questions, the present invention can gain additional insight to assist in deriving the best possible student match for a tour. Further, the present invention can store the questions and answers in order to continually refine and improve its matching capabilities.

Once the additional questions are generated and answered, or if there is not a high-confidence match at step 116, the prospective student's visit is scheduled as at step 122. As at step 124, the prospective student and the guide tour the campus of the school, and as at step 126, the guide enters data for additional questions and/or additional data from the prospective student.

In addition to assisting with matching prospective students with others for a scheduled visit, the matching component 217 of the present invention can assist the admissions office personnel in qualifying candidates for admission as well as determining the most likely candidates from the qualified candidates to accept an offer. The matching component employs a matching algorithm that uses the database, incoming application data and historical data to make this determination. In one embodiment of the present invention, the algorithm can extract geographic data from the primary application-related data and report a prediction pertaining to where the current and future student body will be physically located.

Admissions office interface 16 can allow admissions office personnel to access administration component 213 to enter inquiries, print applications, create CD-ROMs and e-mail applications, for example. The form generation/management component 210 of the present invention allows office personnel to generate personalized labels and letters, such as reminder letters, confirmation letters and status letters, for example. Such generated information can be called secondary application-related information. In one embodiment, customized and personalized communications are automatically created by management component upon receipt of application information from an applicant. The content management component 212 of the present invention allows personnel to view, edit, delete, organize, describe and search the primary application-related information. Both office personnel and applicants have access to a status check mechanism via their respective interfaces.

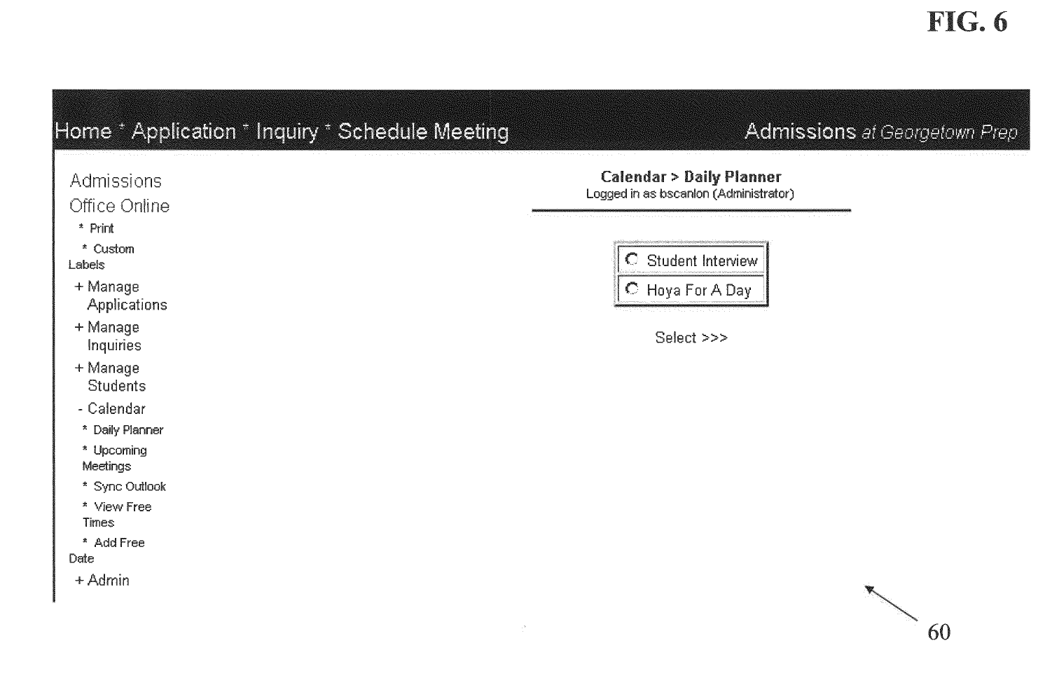

The management component 20 of the present invention can store and monitor status information pertaining to individual applications so as to provide updated status information when queried by applicants, or alternatively when instructed to notify applicants by office personnel. Notifications are also examples of secondary application-related information. As shown in interface 60 of FIG. 6, office personnel and/or administrators can view a calendar to see what their schedule calls for on a given day, for example. Additionally, schedule information can be called up to allow the user to determine available times or dates for an interview or prospective student tour.

In a further embodiment of the invention, the user interfaces can be made available to wireless devices, such as personal digital assistants (PDAs), wireless phones, and other similar devices. Using such interfaces, an admissions personnel might download their schedule information along with personalized notes about a particular applicant, wherein the notes can appear in schedule format. In this way, the admissions personnel might improve the quality of an interview with a prospective candidate by having candidate notes available and at hand during an interview, for example.

An access control component 214 can allow an office administrator to control access to content by giving permissions and access levels to various administration types. For example, one administration type may be provided with access to view applications and provide status reports. A second administration type can be provided with access to review and evaluate applications and provide notes thereto.

Communications component 216 can provide a means for delivery of messages related to applications. For example, communications component can deliver status information to applicants, and can deliver notifications to admissions office personnel notifying them that an application is available for review, or that an application has been assigned to that member, for example. Such notifications are further examples of secondary application-related information. Communications component 216 can facilitate the preparation of information to be sent offline (e.g., printing labels for delivery via traditional mail) and sending information online (such as through e-mail or facsimile).

In one embodiment, the present invention can be integrated with a Dymo Label™ printer for printing labels for mail delivery. This embodiment requires the student information table to be enabled, as is described hereinafter. In another embodiment, the present invention can be integrated with Microsoft Word™ or Excel™, which can also require the student-info table to be enabled. The office user can select an arbitrary number of entries or groupings from the list and print any type of letter or generate different kinds of Excel reports. In one embodiment, a textual summary report and a statistics report are provided.

The administrative personnel can also select an arbitrary number of applicant entries from the list and set their current status or show school codes. Showing school codes shows the passkey for all schools currently known in the student information table. The passkey can be used by principals accessing the system of the present invention for a status view, for example. The status view is a way for students and/or principals to log in and view their current status (or their students' status). An encrypted passkey can be defined for each user and for each school.

Each user can sort columns by representative field, and can edit what fields are shown on his or her list view. In one embodiment, authorized users can edit configuration files to establish field parameters and notification rules. Entries can be viewed, edited and deleted. A configurable number and type of items can be added to each entry. The user can also generate import data that can then be imported into a separate database, such as Blackbaud™, for example. In one embodiment, the data is formatted as comma-separated values.

The admissions or reviewer interface 18 allows the admissions or applicant evaluation personnel to access reviewer component 215 and view primary application-related information, such as a list of submitted forms. Navigation between different types of submitted forms (e.g. applications and inquiries) is through menu selections, hypertext links and other navigation tools commonly known. In one embodiment, the administration interface is only viewable by authenticated users. Review personnel can retrieve primary application-related information from storage, view and print the application-related information, annotate it, update the records, and provide a status for the applicant (e.g., accepted, rejected, wait listed). Any comments, status or modifications are stored with the record of application-related information.

In one embodiment, management component 20 includes programming which allows office personnel to pre-establish which office member and/or reviewing member will be assigned a particular application for review. For example, a first member may be assigned all applications related to applicants for ninth grade, while a second member maybe assigned all applications for a different grade. Applications can be segmented according to applicant age, geographic location, and other fields associated with applicants. E-mails can be sent to the admissions office dependent on an embedded parameter, in one embodiment. The embedded parameter can switch target personnel, such as by, for example, having e-mails related to a certain class of individuals go to a first admissions personnel and the remainder go to a second admissions personnel, as described above.

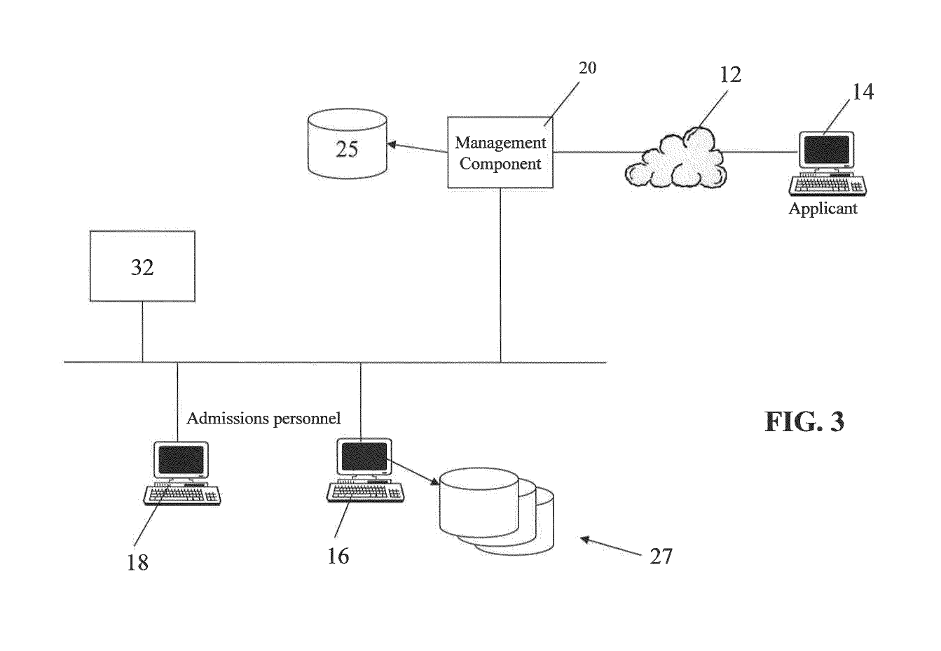

An example architecture of the present invention can appear as is shown in FIG. 3. As shown in FIG. 3, applicant 14 can send application-related information through a network such as the Internet 12 to management component 20, as described earlier. Management component 20 can receive and validate the data and store the data in database 25. Admissions office personnel 16, 18 can retrieve the information from management component 20 and store it locally in the institution databases 27, and can further export the data to database server 32, which can be a Blackbaud™ server as described earlier.

The data can be transmitted to the admissions office personnel by download or via the server 20 of the present invention. Once the data is on the client workstation, it can be imported into the separate database. If configured to use file download, the present invention generates the files and displays a screen where they can be downloaded to the local workstation (e.g. 16). If configured to interface with server 20, the file data is automatically transmitted to the local workstation within the HTML document. The server application can then parse and separate the data into the necessary files.

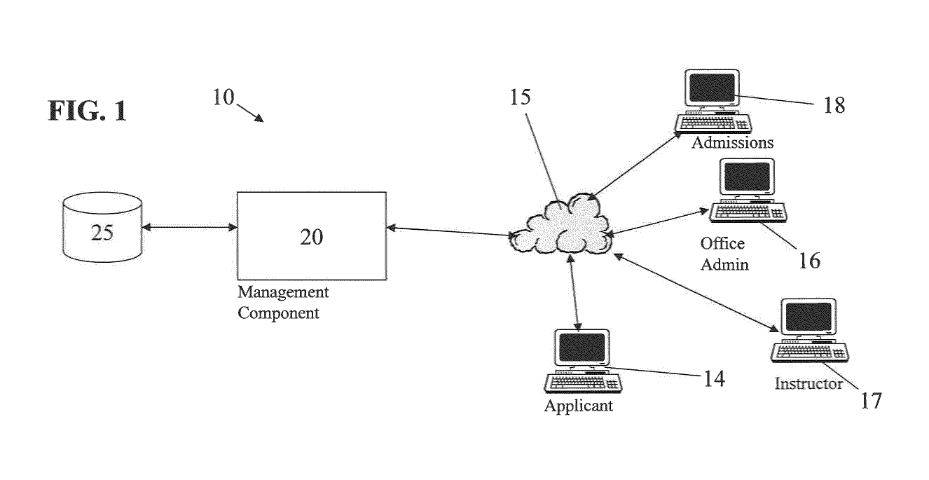

The yield management component 218 can automatically analyze and evaluate the application-related data, comparing selected elements with information in the database to enhance the student selection process. In this way, the yield management component can help determine whether an applicant is likely to accept an offer of admission. Further, the yield management component 218 of the present invention can track applicants through matriculation and record the final institution of their choice, if the selected institution is different from the institution implementing the present invention. The instructor recommendation component 220 can receive instructor recommendation information such as might be provided via instructor interface 17 of FIG. 1.

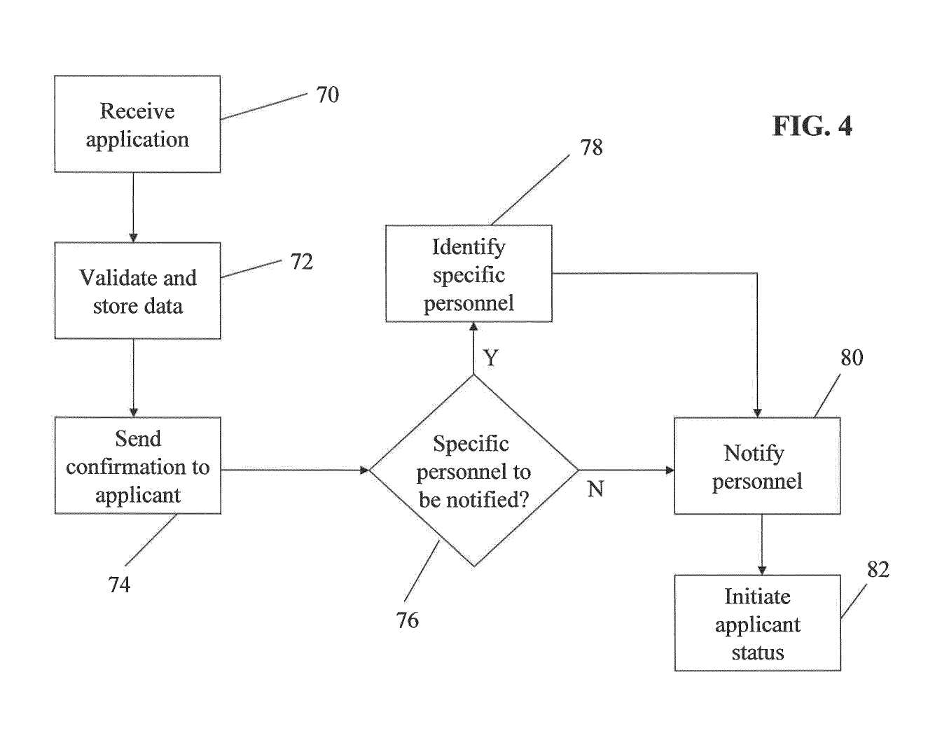

FIG. 4 shows steps involved in application processing in accordance with one embodiment of the invention. An applicant can submit applications and inquiries to the application component using the application interface as described above. The application component of the present invention fields the online forms as at 70, and validates, processes and stores them in a database as at 72. Confirmation emails can be sent as at 74 according to criteria defined in the configuration file and based on data submitted by the user, for example. Notification e-mails to admissions office personnel can also be sent as at 80. In one embodiment, e-mails can be sorted and delivered to different personnel based on a variety of criteria. For example, e-mails for children under the age of seven can be sent to a first individual, and e-mails related to applicants seven years of age and over can be delivered to a second individual. If specific personnel are to be notified as at 76, the determination takes place as at 78. Online forms can be single or multi-page forms, and any documents requested can be received via e-mail attachment as is known in the art. As described above, users can upload files with their form (e.g. pictures). Once the appropriate admissions reviewer personnel receives the application-related information, he or she can review the application and establish a status for the applicant. The applicant's initial status is recorded as at 82.

It will be appreciated that the use of the yield management component, matching component and relevant matching algorithm can be incorporated either before or after application-related information is sent to the reviewer personnel.

The various components of the present invention are built to be extremely flexible, with settings configurable via external configuration files. In one embodiment, the present invention can be developed using Perl™ and can be implemented on an Apache™ web server running the Linux™ operating system or a Unix™-based operating system. The present invention can further be developed using Server Side Includes (SSI) technology, which allows for embedding certain objects or scripts within an HTML document that is parsed and processed by the web server before passing to the client's browser. The present invention can further include a client-side application, which can be written in C+ or C++, for example, simulating both a browser and an HTTP server, wherein the application can incorporate additional functions as desired. The student-mode client application can allow a student to save/load his work, print his application, and submit the application online.

In one embodiment of the present invention, the forecasting component 219 can extract geographic and zip code data to help predict where the current and future student body will be physically located, as well as to provide details on where and how many students should be marketed in the future. The present invention can further provide a computerized dashboard to show the trends and predictions for strategic and business planning purposes. In one embodiment of the present invention, the applicant component can use the application data, marketing data and strategic data to optionally provide dynamic (i.e., real-time or near real-time) response and questions to the applicant during the application process. This can be used, for example, when key criteria are met that indicate an applicant is a potential high or low match rate to past successful students at the institution. In one embodiment of the present invention, the communication mechanism not only provides status to the applicant, but requests other data to refine the data being processed.

In one embodiment, the present invention includes a data bridge component for interfacing with a legacy applicant database, such as Blackbaud™, for example. Blackbaud™ is a database common in schools for maintaining student information, records, etc. The present invention provides a utility for importing data into Blackbaud™. The present invention further has the capability to use MySQL™ as the backend database. MySQL is a popular, fast, easy-to-setup, open-source database that is often used as a backend for web-based applications. In another embodiment, the present invention can interface with a CSV (comma-separated values) type database, often regarded as a pseudo-database. For web-office systems running with a MySQL™ backend, it is possible to integrate Microsoft Access™ as a front-end to all tables in MySQL™ using MyODBC™, for example.

### Access and Navigation

The present invention defines user classes to help control access and capabilities for different types of users. In the preferred embodiment, all users must be authenticated by the system server before accessing any of the system components. There are no “non-logged in” user types. The present invention can accommodate at least three classes of administrative users. First a Guest user is the most limited account, which allows the user to view the entry list for all types and view specific entries. The Office user can be allowed all capabilities except for student information status changes and in some cases, configuration file changes. The Administrative user is the most powerful user type, and can perform all tasks without limitation.

The present invention can include HTML (html/) files to provide forms and navigation for the various software components. Also, CGI-BIN (cgi-bin/) scripts can be employed to handle the form submissions from the HTML components or aid creation of the HTML forms (Server-Side Includes), as is well understood in the art. The data files, or files needed by the present invention to run include configuration files, template files for a variety of tasks, and auxiliary scripts to be run, for example. The admissions or admin file can houses the main script(s) for the present invention and can include an HTML “navigation” page and the main web-office software.

### Data Management

The present invention can accommodate the backend database virtually transparently. In one embodiment, the connection string in the configuration file defines the type of database. With CSV databases, if no user is specified in the configuration file, the present invention attempts to connect without a username/password. For other databases, if a user is specified in the configuration file, the present invention attempts to connect to the database with the username/password.

With regard to database design, the present invention defines several types of tables that generally correspond to form types. The present invention is flexible enough to extend the number and types of tables it can handle.

The database Import Format Mapping Files IFMF is a file that maps data from a “raw data” table to a format that can be imported into a database such as Blackbaud™, for example. Three supported types of importing include biographical information, activities and hobbies, and relationships.

### Interfaces

The dynamic web pages created by the present invention use two files to create a standard look and feel across all of the pages. The header file is printed before the generated dynamic output. Conversely, the footer file is printed afterwards. The present invention can make reference to items that need to be defined in an included stylesheet. An activity mapping file can be used for importing to map “activities” from a “raw data” table to a format that can be imported into an external database such as a Blackbaud™ database, for example. The e-mail script is a separate script that can be used to send e-mail. The log file can be used in two modes, normal and extensive (usually reserved for debugging). All tasks, except the email script use the normal log file. In one embodiment, the email script uses a separate log file.

The master configuration file is what defines the current setup of the present invention. A unique identification file can be used to assign a unique identifier to every submitted entry. The file consists simply of a single line with an arbitrarily large number. If importing into Blackbaud™, for example, it must be a number that Blackbaud™ can handle.

In one embodiment, admissions personnel can customize aspects of the various components of the present invention, including the applicant component, management component and communications component. For example, the admissions personnel may decide to have all applicant communications occur electronically via communications component, or to require personnel review of any outgoing status communication from the management component, or to allow non-applicants, such as parents, to access status information via applicant interface. In one embodiment, any such customized configurations are established via an admissions personnel interface accessible using a client device. Customized configurations can relate to business rules, software integration, hardware integration or database integration, for example. In this way, the invention provides a complete, integrated, customizable, and personalized solution for applicants and admissions personnel.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a non-transitory computer program product, such as a diskette or other recording medium, for use with any suitable data processing system. The present invention can further run on a variety of platforms, including Microsoft Windows™, Linux™, Sun Solaris™, HP/UX™, IBM AIX™ and Java™ compliant platforms, for example.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed and desired to be secured by Letters Patent is:

1. An apparatus, comprising:
a processor; and
a storage device in communication with the processor, the storage device storing instructions that when executed by the processor direct the processor to perform:
receiving primary application-related information, the information including at least applicant identification information;
storing the primary application-related information,
creating and personalizing secondary application-related information based on the primary application-related information; and
comparing historical data from one or more students who have successfully matriculated with the primary application-related information.

2. The apparatus of claim 1 further comprising matching the first user type member with a student for a selected applicant service.

3. The apparatus of claim 1 further comprising extracting geographic data from the primary application-related data and reporting a prediction pertaining to where the current and future student body will be physically located.

4. The apparatus of claim 1 further comprising issuing a response in the form of one or more targeted questions to an applicant during the application process, based on the primary application-related data.

5. The apparatus of claim 1 further comprising comparing primary application-related data to historical student data to determine whether a student candidate is likely to accept an offer of admission.

6. The apparatus of claim 1 further comprising receiving school strategic mission information and comparing the school strategic mission information with the primary application-related information to determine whether to offer admission to an applicant.

7. A system for facilitating the processing and management of applicants, comprising:
at least one processor; and
at least one storage device which stores a plurality of instructions which, when executed by the at least one processor, cause the at least one processor to operate to:
receive and store primary application-related information, including at least applicant identification information;
create and personalize secondary application-related information based on the primary application-related information; and
compare historical data from one or more current students with the primary application-related information.

8. The system of claim 7 further comprising accessing a database of students in order to select a current student for providing the applicant with a selected applicant service.

9. The system of claim 7 further comprising an instructor recommendation component for permitting the submission of recommendations.

10. An article of manufacture comprising a non-transitory computer-readable medium whose stored contents configure a computing device to perform a method for facilitating the processing and management of applicants, the method comprising the steps of:
receiving and storing primary application-related information, the information including at least applicant identification information;
creating and personalizing secondary application-related information based on the primary application-related information; and
comparing historical data from one or more students who have successfully matriculated with the primary application-related information.

11. A content processing and publication tool, comprising:
a server for storing application-related content and programming for managing the content for use in processing at least one application for admission;
a first user interface in communication with the server for enabling at least one member of a first user type from a first client device to submit an application for admission;
a management component in communication with the server for receiving and storing the application, for notifying at least one member of a second user type of the stored application, and for populating secondary application-related information with first user type information; and
a matching component comparing historical data from one or more students who have successfully matriculated with the first user type information to derive a match metric.

12. The tool of claim 11 including:
a second user interface in communication with the server enabling the at least one second user type member from a second client device to receive and view the application for admission and the match metric, submit notes for appending to and storing with the application for admission, and for retrieving schedule information pertaining to at least one member of a first user type; and
a communications component for communicating secondary application-related information to the at least one first user type member.

13. The tool of claim 11 wherein the match metric is associated with a geographic location.

14. The tool of claim 11 wherein the match metric is associated with a demographic characteristic.

15. The tool of claim 11 wherein the match metric is associated with an academic characteristic.
